(19) United States
(12) Patent Application Publication
(10) Pub. No.: US 2026/0268159 A1
(43) Pub. Date: Sep. 10, 2026

(54) METHOD AND APPARATUS WITH NEURAL NETWORK MODEL COMPRESSION

(71) Applicant: SAMSUNG ELECTRONICS CO., LTD., Suwon-si (KR)

(72) Inventors: Yanzhe WANG, Xi’an (CN); Xiao TANG, Xi’an (CN); Donghoon SAGONG, Suwon-si (KR); Feng ZHU, Xi’an (CN); Yunhao ZHANG, Xi’an (CN); Nahyup KANG, Suwon-si (KR)

(73) Assignee: SAMSUNG ELECTRONICS CO., LTD., Suwon-si (KR)

(21) Appl. No.: 19/459,474

(22) Filed: Jan. 26, 2026

(30) Foreign Application Priority Data
Mar. 7, 2025 (CN) 202510271920.5
Sep. 11, 2025 (KR) 10-2025-0130282

(51) Int. Cl. G06N 3/096; G06N 3/0495

(52) U.S. Cl. CPC G06N 3/096; G06N 3/0495

(57) ABSTRACT

A method of compressing an artificial neural network model includes: obtaining a first output of a to-be-compressed model by inputting training data to the to-be-compressed model and obtaining a second output of a teacher model by inputting the training data to the teacher model; obtaining a student model by pruning the to-be-compressed model using a gating network pruning network based on the first output of the to-be-compressed model; obtaining an output of the student model by inputting the training data to the student model; calculating a distillation loss based on the output of the student model and the second output of the teacher model; training the to-be-compressed model and the gating network pruning network based on the distillation loss; and obtaining a compressed model by pruning the trained to-be-compressed model with the trained gating network pruning network.

### CROSS-REFERENCE TO RELATED APPLICATIONS

This application claims the benefit under 35 USC § 119(a) of Chinese Patent Application No. 202510271920.5, filed on Mar. 7, 2025, in the China National Intellectual Property Administration, and Korean Patent Application No. 10-2025-0130282, filed on Sep. 11, 2025, in the Korean Intellectual Property Office, the entire disclosures of which are incorporated herein by reference for all purposes.

### BACKGROUND

### 1. Field

The following description relates to a method and an electronic device with neural network compression.

### 2. Description of Related Art

Deep neural networks are widely used in image processing. Complex deep convolutional neural networks may provide accurate inferences and predictions, but their implementation may require expensive hardware (e.g., graphics processing units (GPUs)). Platforms with limited computing resources may not be capable of executing convolutional neural network-based algorithms, for example, in real time. Such networks may be particularly difficult to apply on embedded platforms and mobile devices with limited computing resources. Model compression technology is sometimes used to improve performance of compute-intensive neural network models.

Most model compression methods are pipelined and usually involve first pruning a network to obtain a simplified network, and then using knowledge distillation to improve the performance of the simplified/compressed network. As observed only by the inventors, such compression methods are prone to producing simplified networks with suboptimal performance since information guidance of (or knowledge transfer from) a teacher model may not be obtained when screening redundant network structures, and, synchronization and optimization of network structures may not be able to be performed when performing knowledge distillation.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of compressing an artificial neural network model includes: obtaining a first output of a to-be-compressed model by inputting training data to the to-be-compressed model and obtaining a second output of a teacher model by inputting the training data to the teacher model; obtaining a student model by pruning the to-be-compressed model using a gating network pruning network based on the first output of the to-be-compressed model; obtaining an output of the student model by inputting the training data to the student model; calculating a distillation loss based on the output of the student model and the second output of the teacher model; training the to-be-compressed model and the gating network pruning network based on the distillation loss; and obtaining a compressed model by pruning the trained to-be-compressed model with the trained gating network pruning network.

The gating network pruning network may include a gating network and a pruning mask, the gating network may include a fully connected layer and a gating function, and the obtaining of the student model by pruning the to-be-compressed model through the gating network pruning network based on the output of the to-be-compressed model includes: in a forward inference process, obtaining an output of the fully connected layer by inputting, to the fully connected layer, an output of a to-be-compressed layer of the to-be-compressed model; calculating a pruning threshold value based on a preset pruning ratio; generating the pruning mask using the gating function based on the output of the fully connected layer and the pruning threshold value; and obtaining the student model by pruning the to-be-compressed model based on the pruning mask.

The gating network pruning network may calculate a gradient of the gating function based on an approximate gating function in a backpropagation process.

The calculating of the distillation loss based on the first output of the student model and the second output of the teacher model may include: extracting a first multi-scale spatial attention feature of the output of the student model by inputting the output of the student model to a multi-scale spatial attention feature extractor, and extracting a second multi-scale spatial attention feature of the second output by inputting the second output to the multi-scale spatial attention feature extractor; and calculating the distillation loss based on the first multi-scale spatial attention feature and the second multi-scale spatial attention feature.

The training of the to-be-compressed model and the gating network pruning network based on the distillation loss may include: training the to-be-compressed model, the gating network pruning network, and the multi-scale spatial attention feature extractor based on the distillation loss.

The calculating of the distillation loss based on the first and second multi-scale spatial attention features may include: calculating a first loss based on a difference between the output of the student model and corresponding ground truth data in the training data; calculating a second loss based on a difference between the first multi-scale spatial attention feature and the second multi-scale spatial attention feature; and calculating the distillation loss based on the first loss and the second loss.

The extracting of the first and second multi-scale spatial attention features may include: extracting a first feature by inputting the output of the student model or the second output to a first convolutional layer of the multi-scale spatial attention feature extractor; extracting a second feature and a third feature by inputting the first feature to a second convolutional layer of the multi-scale spatial attention feature extractor and a third convolutional layer of the multi-scale spatial attention feature extractor, respectively; obtaining a concatenation feature by concatenating the first feature, the second feature, and the third feature; and obtaining the first multi-scale spatial attention feature or the second multi-scale spatial attention feature by inputting the concatenation feature to a fourth convolutional layer of the multi-scale spatial attention feature extractor.

A receptive field of the second feature and a receptive field of the third feature may be different from each other.

The generating of the pruning mask using the gating function based on the output of the fully connected layer and the pruning threshold value may include: assigning 1 to a corresponding value among the pruning mask for a value greater than or equal to the pruning threshold value among the output of the fully connected layer; and assigning 0 to a corresponding value among the pruning mask for a value less than the pruning threshold value among the output of the fully connected layer.

The to-be-compressed model may be obtained by random initialization, the teacher model may be obtained through pre-training, and network structures of the to-be-compressed model and the teacher model may correspond to each other.

In another general aspect, an apparatus for compressing an artificial neural network model includes: one or more processors; and a memory storing instructions configured to, when executed by the one or more processors, cause the apparatus to: obtain a first output of a to-be-compressed model by inputting training data to the to-be-compressed model and obtaining a second output of a teacher model by inputting the training data to the to the teacher model; obtain a student model by pruning the to-be-compressed model through a gating network pruning network based on the first output of the to-be-compressed model; obtain an output of the student model by inputting the training data to the student model; calculate a distillation loss based on the output of the student model and the second output of the teacher model; train the to-be-compressed model and the gating network pruning network based on the distillation loss; and obtain a compressed model by pruning the trained to-be-compressed model, using the trained gating network pruning network.

The gating network pruning network may include a gating network and a pruning mask, the gating network may include a fully connected layer and a gating function, and the instructions may be further configured to cause the apparatus to: in a forward inference process, obtain an output of the fully connected layer by inputting, to the fully connected layer, an output of a to-be-compressed layer of the to-be-compressed model; calculate a pruning threshold value based on a preset pruning ratio; generate the pruning mask using the gating function based on the output of the fully connected layer and the pruning threshold value; and obtain the student model by pruning the to-be-compressed model based on the pruning mask.

The gating network pruning network may calculate a gradient of the gating function based on an approximate gating function in a backpropagation process.

The instructions may be further configured to cause the apparatus to: extract a first multi-scale spatial attention feature of the output of the student model and a second multi-scale spatial attention feature of the second output of the teacher model by inputting the output of the student model and the second output of the teacher model to a multi-scale spatial attention feature extractor, respectively; and calculate the distillation loss based on the first multi-scale spatial attention feature and the second multi-scale spatial attention feature.

The instructions may be further configured to cause the apparatus to train the to-be-compressed model, the gating network pruning, and the multi-scale spatial attention feature extractor based on the distillation loss.

The instructions may be further configured to cause the apparatus to: calculate a first loss based on a difference between the output of the student model and corresponding ground truth data in the training data; calculate a second loss based on a difference between the first multi-scale spatial attention and the second multi-scale spatial attention feature; and calculate the distillation loss based on the first loss and the second loss.

The instructions may be further configured to cause the apparatus to: extract a first feature by inputting the output of the student model or the second output to a first convolutional layer of the multi-scale spatial attention feature extractor; extract a second feature and a third feature by inputting the first feature to a second convolutional layer of the multi-scale spatial attention feature extractor and a third convolutional layer of the multi-scale spatial attention feature extractor, respectively; obtain a concatenation feature by concatenating the first feature, the second feature, and the third feature; and obtain the first multi-scale spatial attention feature or the second multi-scale spatial attention feature by inputting the concatenation feature to a fourth convolutional layer of the multi-scale spatial attention feature extractor.

A receptive field of the second feature and a receptive field of the third feature may be different from each other.

The instructions may be further configured to cause the apparatus to: assign 1 to a corresponding value among the pruning mask for a value greater than or equal to the pruning threshold value among the output of the fully connected layer; and assign 0 to a corresponding value among the pruning mask for a value less than the pruning threshold value among the output of the fully connected layer.

In another general aspect, an electronic device includes: one or more processors including processing circuitry; and a memory storing instructions, wherein the instructions, when executed by the one or more processors, cause the electronic device to: obtain a first output of a student model and an output of a corresponding teacher model by inputting a training data item to the student model and to the teacher model, respectively; prune the student model through gating network pruning based on the first output of the student model; obtain a second output of the student model by inputting the training data item to the pruned student model; calculate a loss based on the second output of the student model and the output of the teacher model; train the student model and the gating network pruning based on the loss; and prune the trained student model through the trained gating network pruning.

### BRIEF DESCRIPTION OF THE DRAWINGS

FIG. 1 illustrates an example of a pruning process, according to one or more embodiments.

FIG. 2 illustrates an example of a process of knowledge distillation, according to one or more embodiments.

FIG. 3 illustrates an example of an overall process of a model compression method, according to one or more embodiments.

FIG. 4 illustrates an example of a process of a model compression method, according to one or more embodiments.

FIG. 5 illustrates an example of a data processing process of gating network pruning, according to one or more embodiments.

FIG. 6 illustrates an example of a process of calculating a distillation loss based on multi-scale spatial attention features, according to one or more embodiments.

FIG. 7 illustrates an example of a model compression apparatus, according to one or more embodiments.

FIG. 8 illustrates an example of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

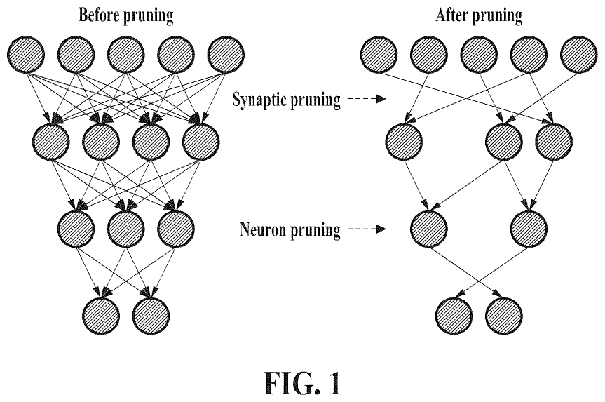

FIG. 1 illustrates an example of a pruning process, according to one or more embodiments.

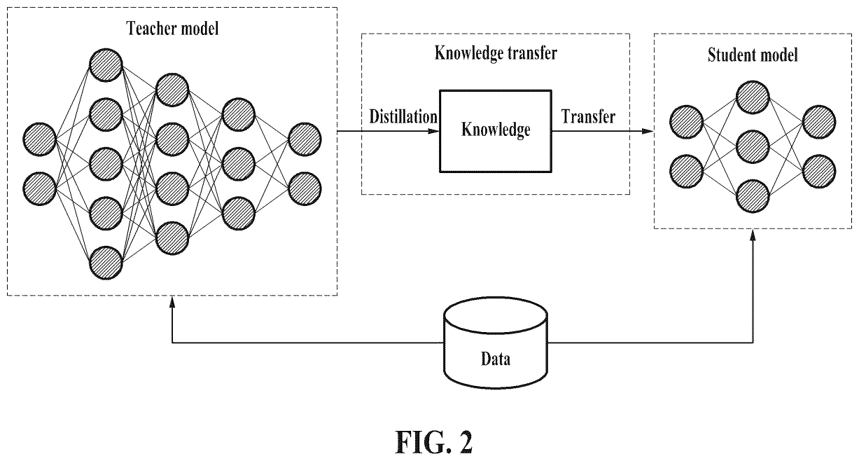

FIG. 2 illustrates an example of a process of knowledge distillation, according to one or more embodiments.

Referring to FIGS. 1 and 2, both pruning and knowledge distillation may be used for model compression. Pruning may involve obtaining a simplified network by removing unnecessary parameters such as synapses and/or neurons after model training is complete. However, pruning may cause some accuracy loss by making a neural network's network structure random and sparse, and, after pruning, it is generally necessary to improve performance again using additional methods such as fine-tuning or knowledge distillation.

In the knowledge distillation approach, an output of a pre-trained complex model (e.g., a teacher model) may be used as a supervision signal to train another relatively simpler network (e.g., a student model). The knowledge distillation may primarily train a randomly initialized simple network, and its results may depend on the design and training method of the simple network.

For further improved model compression performance, the pruning and the knowledge distillation may be combined. The pruning and the knowledge distillation method may be combined in a pipelined manner. That is, first, the pruning may be performed to obtain a simplified network, and then the simplified network may be trained to mimic the output of a complex teacher network through the knowledge distillation, thereby improving the accuracy of the simplified network.

In the pipelined manner, pruning may be performed first and then distillation may be performed, however, the stepwise optimization strategy may not obtain a simplified network with improved overall performance through joint optimization, and a suboptimization problem may occur. In addition, when pruning is performed according to a set threshold value, the efficacy of the pruning may depend on the setting of the threshold value. In addition, efficacy of pruning according to the typical L1 norm may be affected by the selection of pruning criteria.

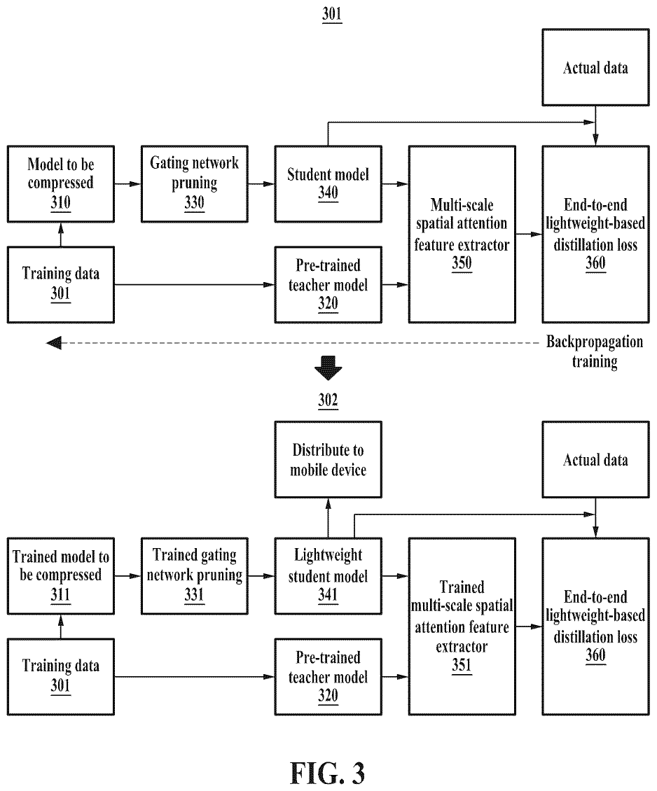

Previously, when performing knowledge distillation, the consistency of multi-scale spatial attention features between a teacher model and a student model has not been used for supervision, and distillation accuracy in general has not been improved. In addition, a feature extractor (see multi-scale spatial attention feature extractor 350 in FIG. 3 for example) has a large number of parameters, and thus, it may be difficult to perform optimization of the feature extractor when it is being trained simultaneously with a student network that is in an initialized state.

To solve some of the above problems, embodiments and examples described below propose an end-to-end artificial neural network model compression method (referred to herein as a model compression method) that combines pruning and knowledge distillation. In some example implementations, a student model may be obtained by pruning a randomly initialized to-be-compressed model, using an automatic pruning method based on gating network pruning, and performing knowledge distillation based on the student model and a teacher model.

According to an example, the gating network pruning may be performed in a gating network pruning module. Here, the term “module” may refer to a functional and structural unit that performs a specific function or a defined set of operations, and may be implemented as software, hardware, or a combination of hardware and software. For example, the module may be a set of program code, functions, procedures, or routines configured to perform a specific task, or may refer to a physical device or circuit designed to perform specific logic, such as a processor, an application-specific integrated circuit (ASIC), or a field programmable gate array (FPGA). Therefore, the term “module” used herein should be interpreted to encompass all kinds of implementations that may independently perform the specified function.

An electronic device may obtain a final lightweight student model using gating network pruning by optimizing the gating network pruning while (jointly with) optimizing parameters of a to-be-compressed model using a distillation loss. Such joint optimization of the model compression method may include performing joint optimization during the model compression process by integrating the pruning and the knowledge distillation, simultaneously selecting redundant network structures and receiving information supervision of a teacher model, and simultaneously optimizing the network structure while performing knowledge distillation to obtain a compressed model with improved performance.

Examples and embodiments of the model compression method are described next with reference to FIGS. 3 to 8.

FIG. 3 illustrates an example of an overall process of a model compression method, according to one or more embodiments.

One or more blocks and a combination of the blocks of FIG. 3 may be implemented by a special-purpose hardware-based computer that performs a predetermined function or a combination of computer instructions and special-purpose hardware, and may operate in an electronic device 800 of FIG. 8.

Referring to FIG. 3, in training operation 301, an electronic device may obtain an output of a to-be-compressed model 310 and an output of a teacher model 320 by inputting training data 301 to the to-be-compressed model 310 and the teacher model 320, respectively. Then, based on the output of the to-be-compressed model 310, the electronic device may obtain a student model 340 by pruning the to-be-compressed model 310 through gating network pruning.

Then, the electronic device may extract a multi-scale spatial attention feature of the output of the student model 340 and a multi-scale spatial attention feature of the output of the teacher model 320 by inputting the output of the student model 340 and the output of the teacher model 320 to a multi-scale spatial attention feature extractor 350, respectively. Here, the multi-scale spatial attention feature extractor may be a multi-scale spatial attention feature module. As discussed below, a multi-scale spatial attention feature extractor may be a neural network component that adaptively fuses information from different resolution levels to enhance a model's ability to focus on the most relevant parts of an input (e.g., an image). Multi-scale spatial attention feature extraction may combine advantages of (i) multi-scale feature extraction, which extracts details at different granularities (e.g., fine textures and global context), and (ii) spatial attention, which assigns higher importance to specific regions. This may enable a model to improve performance on tasks like object detection, segmentation, and gesture recognition by simultaneously considering both the big picture and the small details.

Finally, the electronic device may, based on the multi-scale spatial attention feature extracted from the output of the student model 340 and the multi-scale spatial attention feature extracted from the output of the teacher model 320, (i) calculate an end-to-end lightweight-based distillation loss 360 by combining the output of the student model 340 with actual data, and (ii) train the to-be-compressed model 310, gating network pruning 330, and the multi-scale spatial attention feature extractor 350 by backpropagation based on the distillation loss 360. In other words, a parent-teacher type of knowledge distillation architecture may be combined with gating network pruning and multi-scale spatial attention.

The electronic device may repeat training operation 301. When performing training operation 301, the electronic device may perform training operation 301 by training each of: the to-be-compressed model 310, the gating network pruning 330, and the multi-scale spatial attention feature extractor 350 by backpropagation. Each subsequent training pass/iteration may update the trained to-be-compressed model 311, the trained gating network pruning 331, and the trained multi-scale spatial attention feature extractor 351 to latest trained versions thereof.

When the training is complete, in distribution operation 302, the electronic device may obtain a compressed model, that is, a lightweight student model 341 by pruning the trained to-be-compressed model 311 (here, the student model 340 may be used instead of the trained to-be-compressed model 311) through the trained gating network pruning 331, and may distribute the lightweight student model 341 to a mobile device.

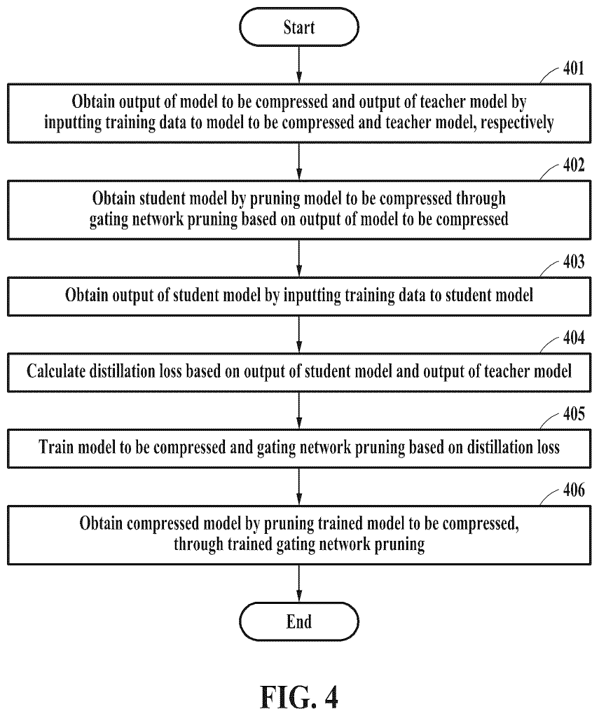

FIG. 4 illustrates an example of a process of a model compression method, according to one or more embodiments.

The description provided with reference to FIGS. 1 to 3 is generally applicable to FIG. 4.

For ease of description, operations 401 to 406 are described as being performed using the electronic device 800 illustrated in FIG. 8. However, operations 401 to 406 may be performed by another suitable electronic device in a suitable system.

In operation 401, an electronic device may obtain an output of the to-be-compressed model 310 and an output of the teacher model 320 by inputting the training data 301 to the to-be-compressed model 310 and the teacher model 320, respectively.

According to an example, network structures of the to-be-compressed model 310 and the teacher model 320 may correspond to each other, the teacher model 320 may be obtained through pre-training, and the to-be-compressed model 310 may be obtained by random initialization. The application fields of the to-be-compressed model 310 may include at least one of image processing, natural language processing, audio processing, numerical processing, and time series processing. The application fields of the to-be-compressed model 310 may be in the field of deep learning and may include, for example, image processing, natural language processing, audio processing, numerical processing, or time series processing, among others. The application fields of the teacher model 320 may also correspond to those of the to-be-compressed model 310.

In addition, the to-be-compressed model 310 and the teacher model 320 have the same network structure, in terms of layer structures, parameter settings of the layers, connection methods, activation functions, regularization methods, and/or the like.

When the to-be-compressed model 310 is applied to the field of image processing, the training data 301 may be image data. When the to-be-compressed model 310 is applied to the field of natural language processing, the training data 301 may be text data, and when the to-be-compressed model 310 is applied to the field of audio processing, the training data 301 may be audio data. When the to-be-compressed model 310 is applied to the field of time series processing, the training data 301 may be time series data. The teacher model 320 may be pre-trained using other data sets that match the relevant application fields or tasks described above. In the following description, the case in which, the to-be-compressed model 310 and the teacher model 320 are applied to the field of image processing and the training data 301 is image data, will be described as a non-limiting example. In addition, the network structure of the to-be-compressed model 310 and the teacher model 320 may be ResNet50, but may also be another deep learning network, and the examples described here are not limited thereto. That is to say, the techniques may be applied to any type of neural network model.

Specifically, the output (operation 401) of the to-be-compressed model 310 may include a final output thereof (e.g., an output of a final layer) and the output of the teacher model 320 may include an output of an intermediate layer thereof, but examples are not limited thereto.

In operation 402, the electronic device may obtain the student model 340 by pruning the to-be-compressed model 310 through the gating network pruning 330, and such pruning may be based on the output of the to-be-compressed model 310.

Specifically, the to-be-compressed model 310 may be, for example, a model randomly initialized during the training process (e.g., before training begins, before a training epoch, etc.), and the student model 340 may be obtained by pruning the to-be-compressed model 310. In a subsequent training cycle, a new pruning process may be repeatedly performed using the student model 340 as a new to-be-compressed model 310. That is, the student model 340 may be refined through repeated training cycles.

According to an example, the gating network pruning 330 may include a gating network and a pruning mask, but examples are not limited thereto. The gating network may include a fully connected layer and a gating function, but examples are not limited thereto. For example, the gating network may have a more complex structure that includes two or more fully connected layers to learn the importance of channels more precisely, or includes other types of layers, such as convolutional layers. To elaborate, a gating network (or sub-network) in a neural network may control the flow of information in the network by determining what data passes through and what data is blocked. By using gates, the network can selectively retain relevant information and forget irrelevant data, which can be beneficial in processing sequential data to manage long-term dependencies and to avoid issues like vanishing gradients. Regarding the control of information flow, a “gate” may acts as a kind of filter, deciding whether to pass information forward.

The process of obtaining the student model 340 by inputting the to-be-compressed model 310 and the output of the to-be-compressed model 310 into the gating network pruning 330 may include, for example, the following operations, but is not limited thereto.

According to an example, the electronic device may, in a forward inference process, (i) obtain an output of the fully connected layer by inputting an output of a to-be-compressed layer (of the to-be-compressed model 310) to the fully connected layer, and (ii) calculate a pruning threshold value based on a preset pruning ratio.

The electronic device according to an example may generate a pruning mask using the gating function based on the output of the fully connected layer and the pruning threshold value.

The electronic device according to an example may obtain the student model 340 by pruning the to-be-compressed model 310 based on the pruning mask.

The implementation method of the gating network is not limited to the methods listed above; the gating network may be implemented in other forms. To simplify the network structure and facilitate parameter training, the gating network may be implemented with only a single fully connected layer and a gating function. In addition, a to-be-compressed layer in the to-be-compressed model 310 may be determined according to a specific requirement. For example, the layer to be compressed may be a convolutional layer, but is not limited thereto. Any type of layer of a neural network including parameters, such as a fully connected layer, an attention layer, or a recurrent neural network (RNN) layer, may be the target of pruning.

According to an example, the electronic device may obtain an output x of the fully connected layer, and then calculate a pruning threshold value θ based on the preset pruning ratio. Then, the electronic device may generate the pruning mask using the gating function based on the output x of the fully connected layer and the pruning threshold value θ. Finally, the electronic device may generate the lightweight student model 341 by pruning the to-be-compressed model 310 based on the pruning mask.

According to an example, the process of the electronic device generating the pruning mask using the gating function based on the output of the fully connected layer and the pruning threshold value may include, but is not limited to, the following operations.

The electronic device may assign 1 to a corresponding value among the pruning mask for a value greater than or equal to the pruning threshold value among the output of the fully connected layer. The electronic device may assign 0 to a corresponding value among the pruning mask for a value less than the pruning threshold value among the output of the fully connected layer. Some additional explanation follows.

Specifically, the gating function gate_function(⋅) may operate as described by Equation 1 below, but is not limited thereto.

$$gate\_function ( x ) = \{ \begin{matrix}1 , x \geq θ \\ 0 , x < θ\end{matrix} \qquad Equation 1$$

Further regarding the gating function, in a neural network, each neuron of a fully connected layer (or a dense layer) may generate one output value. At this time, the pruning mask is a binary matrix (or vector) with the same form as the output of the fully connected layer (e.g., a bit/element for each neuron), and each element thereof may only have a value 0 or 1. 1 indicates that a corresponding neuron or weight (of the layer to which the mask is applied) is preserved, and 0 indicates that it is effectively pruned (i.e., set to 0). At positions where the output of the fully connected layer is greater than or equal to the pruning threshold value, the corresponding positions in the pruning mask may be set to 1, which indicates that the corresponding neurons or weights are preserved. On the other hand, at positions where the output is less than the pruning threshold value, the corresponding positions in the pruning mask may be set to 0, which indicates that the corresponding neuron or weight is pruned.

According to an example, the gating network pruning 330 may further include, but is not limited to, an approximate gating function. In the backpropagation process, a gradient of the gating function may be calculated based on the approximate gating function, and the approximate gating function may be obtained based on a sigmoid function.

Specifically, since the gating function is non-differentiable, in the backpropagation process, the electronic device may implement an approximate gating function using a differentiable function. An approximate gating function may be implemented as described by Equation 2 below (but not limited thereto) based on the sigmoid function.

$$σ ( x ) = \frac{1}{1 + {e}^{- k ( x - θ )}} \qquad Equation 2$$

In Equation 2, k is a hyperparameter, and θ is a pruning threshold value obtained during a forward inference process.

In addition to the sigmoid function, other differentiable function-based gating functions are also possible, and the described examples are not limited thereto.

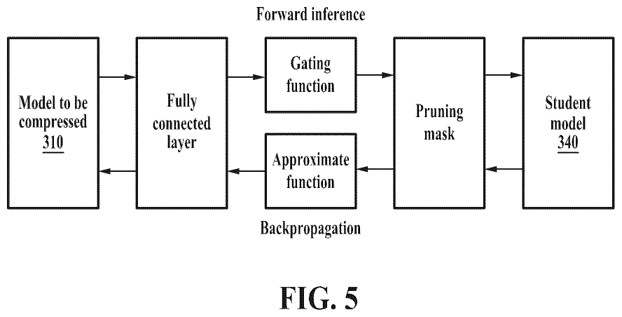

FIG. 5 illustrates an example of a data processing process of gating network pruning, according to one or more embodiments.

The description provided with reference to FIGS. 1 to 4 is generally applicable to FIG. 5.

Referring to FIG. 5, the electronic device may, in a forward inference process, obtain an output of the fully connected layer by inputting an output of a to-be-compressed layer of the to-be-compressed model 310 to the fully connected layer. The electronic device may then calculate a pruning threshold value based on a preset pruning ratio. Then, the electronic device may generate the pruning mask using the gating function based on the output of the fully connected layer and the pruning threshold value, and obtain the student model 340 by pruning the to-be-compressed model 310 based on the pruning mask. In the backpropagation process, the electronic device may calculate the gradient of the gating function based on a differentiable approximate gating function.

Referring back to FIG. 4, in operation 403, the electronic device may obtain an output of the student model 340 by inputting the training data 301 to the student model 340. Specifically, the output of the student model 340 may include, but is not limited to, a final output and an output of an intermediate layer.

In operation 404, the electronic device may calculate the distillation loss 360 based on the output of the student model 340 and the output of the teacher model 320. For example, the distillation loss 360 may be calculated in various ways, such as Kullback-Leibler (KL) divergence (also called relative entropy), cross entropy loss, mixing loss, attention transfer loss, feature matching loss, or the like, as non-limiting examples.

According to an example, the process of calculating the distillation loss 360 based on the output of the student model 340 and the output of the teacher model 320 may be performed in the following operations. However, the described examples are not limited thereto.

The electronic device may extract a multi-scale spatial attention feature from the output of the student model 340 and may extract a multi-scale spatial attention feature from the output of the teacher model 320 by inputting (separately) the output of the student model 340 and the output of the teacher model 320 to a multi-scale spatial attention feature extractor 350, respectively.

The electronic device may calculate the distillation loss 360 based on the multi-scale spatial attention feature of the output of the student model 340 and the multi-scale spatial attention feature of the output of the teacher model 320.

The calculation method of the distillation loss 360 based on the multi-scale spatial attention feature is not limited to that described herein, and other methods may also be used. For example, a distributional difference between the student model 340 and the teacher model 320 in the multi-scale spatial attention feature may be measured using the KL divergence or the cross entropy loss.

According to an example, the process of extracting the multi-scale spatial attention feature of the output of the student model 340 and the multi-scale spatial attention feature of the output of the teacher model 320 by inputting the output of the student model 340 and the output of the teacher model 320 to the multi-scale spatial attention feature extractor 350, respectively may be implemented based on an intermediate layer output of the student model 340 and an intermediate layer output of the teacher model 320.

More specifically, the electronic device may separately input the intermediate layer output of the student model 340 and the intermediate layer output of the teacher model 320 into the multi-scale spatial attention feature extractor 350.

The electronic device may perform the following operations through the multi-scale spatial attention feature extractor 350. However, the described examples are not limited thereto.

The electronic device may extract a first feature by inputting the intermediate layer output of the student model 340 or the intermediate layer output of the teacher model 320 (as the case may be) to a first convolutional layer of the multi-scale spatial attention feature extractor 350.

The electronic device may extract a second feature and a third feature by inputting the first feature to a second convolutional layer of the multi-scale spatial attention feature extractor 350 and to a third convolutional layer of the multi-scale spatial attention feature extractor 350, respectively. Receptive fields of the second feature and the third feature may be different from each other. Receptive fields of the second convolutional layer and the third convolutional layer may be different from each other.

A receptive field is a specific field on input data (e.g., an input image) that affects a single neuron in a specific layer of a convolutional neural network (CNN). In general, as the size of a filter or a kernel used in a convolution operation increases, a receptive field of the operation increases. For example, a kernel with a size of 5×5 may collect information from a wider input area at once than a kernel with a size of 3×3.

The reason for using convolutional layers with different receptive fields in parallel is to effectively capture multi-scale spatial information contained in the input data. Convolution with a relatively small receptive field (e.g., 3×3 convolution) may be advantageous for extracting a fine-grained feature such as a local texture or edge of an image. Convolution with a relatively large receptive field (e.g., 5×5 convolution) may extract a global feature, such as a shape of an object or a relationship between parts, by considering a wider range of context.

Therefore, in the described example, as the features extracted from receptive fields with various sizes are combined (concatenated), it is possible to improve the accuracy of knowledge distillation by inducing the student model to more precisely mimic rich and multi-layered spatial information of the teacher model.

The electronic device may obtain a concatenation feature by concatenating the first feature, the second feature, and the third feature.

The electronic device may obtain the multi-scale spatial attention feature of the intermediate layer output of the student model 340 or the multi-scale spatial attention feature of the intermediate layer output of the teacher model 320 by inputting the concatenation feature to a fourth convolutional layer of the multi-scale spatial attention feature extractor 350.

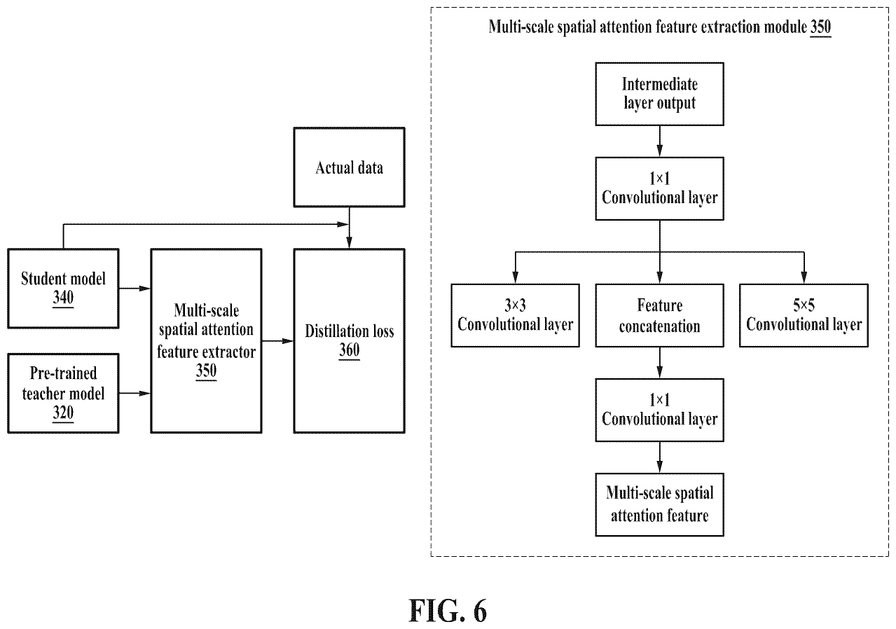

The calculation process of the distillation loss 360 based on the multi-scale spatial attention features is described with reference to FIG. 6.

FIG. 6 illustrates an example of a process of calculating the distillation loss 360 based on multi-scale spatial attention features, according to one or more embodiments.

The description provided with reference to FIGS. 1 to 5 is generally applicable to FIG. 6.

Referring to FIG. 6, the electronic device may input an intermediate layer output of the student model 340 and an intermediate layer output of the pre-trained teacher model 320 into the multi-scale spatial attention feature extractor 350, respectively.

For example, the multi-scale spatial attention feature extractor 350 may include the following. The multi-scale spatial attention feature extractor 350 may include a first convolutional layer (e.g., a 1×1 convolutional layer or a convolutional layer of another receptive field), a second convolutional layer (e.g., a 3×3 convolutional layer or a convolutional layer of another receptive field), a third convolutional layer (e.g., a 5×5 convolutional layer or a convolutional layer of another receptive field), and/or a fourth convolutional layer (e.g., a 1×1 convolutional layer or a convolutional layer of another receptive field).

The structure shown in FIG. 6 is merely an example for extracting the multi-scale features and is not limited thereto. For example, variations are possible, such as using atrous convolutions with different dilation rates, or combining different pooling techniques to extract features from different receptive fields.

The electronic device may extract the first feature by inputting the intermediate layer output of the student model 340 or the intermediate layer output of the teacher model 320 to the first convolutional layer (e.g., the 1×1 convolutional layer) of the multi-scale spatial attention feature extractor 350.

Thereafter, the electronic device may extract the second feature and the third feature by inputting the first feature to the second convolutional layer (e.g., the 3×3 convolutional layer) and the third convolutional layer (e.g., the 5×5 convolutional layer), respectively. Through this, the electronic device may extract features at different scales through the convolutions with different receptive fields.

The electronic device may obtain a concatenation feature by concatenating the first feature, the second feature, and the third feature. Finally, the electronic device may obtain the multi-scale spatial attention feature (of the intermediate layer output of the student model 340 or the multi-scale spatial attention feature of the intermediate layer output of the teacher model 320) by inputting the concatenation feature to the fourth convolutional layer (e.g., 1×1 convolutional layer).

The process of calculating the distillation loss 360 based on the multi-scale spatial attention feature of the output of the student model 340 and the multi-scale spatial attention feature of the output of the teacher model 320 may include the following operations, but the described examples are not limited thereto.

The electronic device may calculate a first loss based on a difference between the output of the student model 340 and corresponding actual data in the training data.

The electronic device may calculate a second loss based on a difference between the multi-scale spatial attention feature of the intermediate layer output of the student model 340 and the multi-scale spatial attention feature of the intermediate layer output of the teacher model 320.

The electronic device may calculate the distillation loss 360 based on the first loss and the second loss.

Specifically, the calculation method of the distillation loss 360 may be performed as in Equations 3 to 5, but is not limited thereto.

$${Loss}_{KD} = {Loss}_{GT} + μ * {Loss}_{ST} \qquad Equation 3$$

In Equation 3, Loss_{KD} is the distillation loss 360, Loss_{GT} is the first loss, μ is a hyperparameter that may be set to 0.25 or other possible values, and Loss_{ST} is the second loss. The hyperparameter μ is shown as an example of 0.25, but this may be adjusted to the optimal value empirically or through a verification dataset.

$${Loss}_{GT} = ‖ {I}_{S} - {I}_{GT} ‖ \qquad Equation 4$$

In Equation 4, I_{S} is a final output of the student model 340 (which may be an image) and I_{GT} is corresponding actual data (i.e., actual image, label) in the training data 301. Here, a first loss L1 may use various loss functions such as a mean square error (MSE), cross-entropy, or L1 loss depending on the type of task.

$${Loss}_{ST} = ‖ {F}_{S} - {F}_{T} ‖ \qquad Equation 5$$

In Equation 5, F_{S} is a multi-scale spatial attention feature output by the intermediate layer of the student model 340, and F_{T} is a multi-scale spatial attention feature output by the intermediate layer of the teacher model 320.

Referring back to FIG. 4, in operation 405, the electronic device may train the to-be-compressed model 310 and the gating network pruning 330 based on the distillation loss 360.

More specifically, the electronic device may extract the output multi-scale spatial attention feature of the pruned to-be-compressed model 310 and the output multi-scale spatial attention feature of the teacher model 320 using the multi-scale spatial attention feature extractor 350.

At this time, the electronic device may train the to-be-compressed model 310, the gating network pruning 330, and the multi-scale spatial attention feature extractor 350 in the end-to-end (E2E) manner based on the distillation loss 360, thereby improving together the feature extraction effect of the multi-scale spatial attention feature extractor 350 and enabling it to be used in subsequent compression operations.

In operation 406, the electronic device may obtain a compressed model by pruning the to-be-compressed model 310 using the trained gating network pruning 331.

Specifically, the compressed model may be the lightweight student model 341. The compressed model may be a production model that may be distributed to mobile devices or the like.

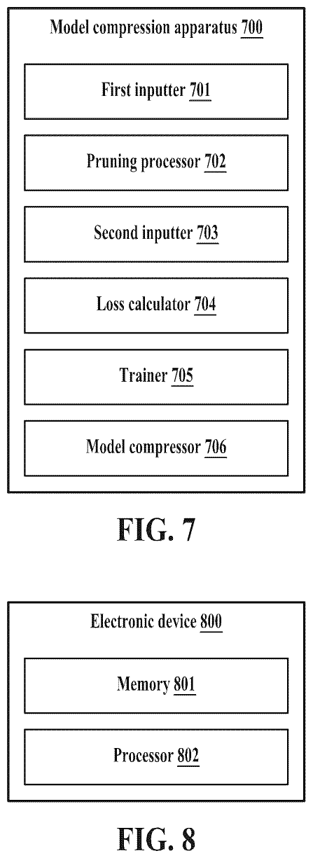

FIG. 7 illustrates an example of a model compression apparatus, according to one or more embodiments.

The description provided with reference to FIGS. 1 to 6 is generally applicable to FIG. 7.

Referring to FIG. 7, in an example, a model compression apparatus 700 may include a first inputter 701, a pruning processor 702, a second inputter 703, a loss calculator 704, a trainer 705, and a model compressor 706, but is not limited thereto.

According to an example, each of the first inputter 701, the pruning processor 702, the second inputter 703, the loss calculator 704, the trainer 705 and the model compressor 706 may be a unit. The term “unit” refers to a logical or physical component unit configured to perform a specific function or role described herein. These unit may be implemented as hardware, software, or a combination thereof, and is not limited to any particular implementation form. For example, when implemented in hardware, the unit may include processor, an application-specific integrated circuit (ASIC), a field-programmable gate array (FPGA), or other integrated circuit that performs a specific operation, and when implemented as software, the unit may be a collection of program code, a set of instructions, a function, an object, or a subroutine that is stored in a memory and executed by a processor to perform a specific function. Therefore, each unit of the described examples should be understood to refer to a comprehensive means for performing the specified operation.

The first inputter 701 may obtain an output of the to-be-compressed model 310 and an output of the teacher model 320 by inputting the training data 301 to the to-be-compressed model 310 and the teacher model 320, respectively. Network structures of the to-be-compressed model 310 and the teacher model 320 may correspond to each other, the teacher model 320 may be obtained through pre-training, and the to-be-compressed model 310 may be obtained by randomly initializing. The application fields of the to-be-compressed model 310 may include at least one of image processing, natural language processing, audio processing, numerical processing, and time series processing.

The pruning processor 702 may obtain the student model 340 by pruning the to-be-compressed model 310 through the gating network pruning based on the output of the to-be-compressed model 310.

The second inputter 703 may obtain an output of the student model 340 by inputting the training data 301 to the student model 340.

The loss calculator 704 may calculate the distillation loss 360 based on the output of the student model 340 and the output of the teacher model 320.

The trainer 705 may train the to-be-compressed model 310 and the gating network pruning 330 based on the distillation loss 360.

The model compressor 706 may obtain a compressed model by pruning the trained to-be-compressed model 311 through the trained gating network pruning 331.

According to an example, the gating network pruning 330 may include a gating network and a pruning mask, and the gating network may include a fully connected layer and a gating function.

The pruning processor 702 may, in a forward inference process, obtain an output of the fully connected layer by inputting an output of a layer to be compressed of the to-be-compressed model 310 to the fully connected layer. The pruning processor 702 may calculate a pruning threshold value based on a preset pruning ratio. The pruning processor 702 may generate a pruning mask using the gating function based on the output of the fully connected layer and the pruning threshold value. The pruning processor 702 may obtain the student model 340 by pruning the to-be-compressed model 310 based on the pruning mask.

According to an example, the gating network pruning 330 may further include an approximate gating function. The model compression apparatus 700 may further include a gradient calculator (not shown) configured to calculate a gradient of the gating function based on the approximate gating function during the backpropagation process. The approximate gating function may be obtained based on a sigmoid function.

The pruning processor 702 may assign 1 to a corresponding value among the pruning mask for a value greater than or equal to the pruning threshold value among the output of the fully connected layer. The pruning processor 702 may assign 0 to a corresponding value among the pruning mask for a value less than the pruning threshold value among the output of the fully connected layer.

According to an example, the loss calculator 704 may input the output of the student model 340 and the output of the teacher model 320 into the multi-scale spatial attention feature extractor 350, respectively. The loss calculator 704 may extract the multi-scale spatial attention feature of the output of the student model 340 and the multi-scale spatial attention feature of the output of the teacher model 320. The loss calculator 704 may calculate the distillation loss 360 based on the multi-scale spatial attention feature of the output of the student model 340 and the multi-scale spatial attention feature of the output of the teacher model 320. The trainer 705 may train the to-be-compressed model 310, the gating network pruning 330, and the multi-scale spatial attention feature extractor 350 based on the distillation loss 360.

The loss calculator 704 may calculate a first loss based on a difference between the output of the student model 340 and corresponding actual data in the training data 301. The loss calculator 704 may calculate a second loss based on a difference between the multi-scale spatial attention feature of the output of the student model 340 and the multi-scale spatial attention feature of the output of the teacher model 320. The loss calculator 704 may calculate the distillation loss 360 based on the first loss and the second loss.

According to an example, the loss calculator 704 may input the output of the student model 340 and the output of the teacher model 320 into the multi-scale spatial attention feature extractor 350, respectively, and perform the following operations through the multi-scale spatial attention feature extractor 350.

The loss calculator 704 may extract a first feature by inputting the output of the student model 340 or the output of the teacher model 320 to a first convolutional layer of the multi-scale spatial attention feature extractor 350.

The loss calculator 704 may extract a second feature and a third feature by inputting the first feature to a second convolutional layer of the multi-scale spatial attention feature extractor 350 and a third convolutional layer of the multi-scale spatial attention feature extractor 350, respectively. Receptive fields of the second feature and the third feature may be different from each other.

The loss calculator 704 may obtain a concatenation feature by concatenating the first feature, the second feature, and the third feature.

The loss calculator 704 may obtain the multi-scale spatial attention feature of the output of the student model 340 or the multi-scale spatial attention feature of the output of the teacher model 320 by inputting the concatenation feature to a fourth convolutional layer of the multi-scale spatial attention feature extractor 350.

The pruning processor 702 may assign 1 to a corresponding value among the pruning mask for a value greater than or equal to the pruning threshold value among the output of the fully connected layer.

The pruning processor 702 may assign 0 to a corresponding value among the pruning mask for a value less than the pruning threshold value among the output of the fully connected layer.

The specific implementation process of the model compression apparatus 700 according to an example is substantially the same as the example of the model compression method described above, and therefore is not described again herein.

The model compression apparatus 700 may be configured by software, hardware, firmware, or any combination thereof to perform predetermined functions. For example, the apparatus may be implemented as dedicated integrated circuits, as pure software code, or as a combination of software and hardware. In addition, one or more functions implemented by the apparatus may be integrally performed by components of a physical device (e.g., a processor, a client, or a server).

FIG. 8 illustrates an example of an electronic device, according to one or more embodiments.

Referring to FIG. 8, the electronic device 800 may include at least one memory 801, and at least one processor 802. The at least one memory 801 may store computer-executable instructions (e.g., instructions in an instruction set) or code. When the computer-executable instructions or code is executed by the at least one processor 802, the model compression method according to the example is performed.

For example, the electronic device 800 may be a personal computer (PC), a tablet device, a personal digital assistant (PDA), a smartphone, or other devices for executing the instruction set. Here, the electronic device 800 may not need to be a single electronic device and may be any device or assembly of a circuit capable of executing the above instructions (or an instruction set) alone or jointly. The electronic device 800 may also be a part of an integrated control system or a system manager, or may be configured as a portable electronic device that locally or remotely (e.g., via wireless transmission) interfaces.

In the electronic device 800, the at least one processor 802 may be/include a central processing unit (CPU), a GPU, a programmable logic device, a dedicated processor system, a microcontroller, and/or a microprocessor. In addition, the processor may further be/include, for example, but is not limited thereto, an analog processor, a digital processor, a microprocessor, a multicore processor, a processor array, or a network processor.

The processor 802 may execute the instructions or code stored in the memory 801. The memory 801 may further store data. The instructions and data may also be transmitted and received over a network via a network interface device. The network interface device may utilize any known transport protocol.

The memory 801 may be integrated with the processor 802 by arranging, for example, random-access memory (RAM) or flash memory in an integrated circuit microprocessor, or the like. In addition, the memory 801 may include an independent device, such as an external disk drive, a storage array, or other storage devices that may be used by any database system. The memory 801 and the processor 802 may be operatively connected to each other or may communicate with each other through an input/output (I/O) port or a network connection so that the processor 802 may read a file stored in the memory 801.

In addition, the electronic device 800 may further include a video display (e.g., a liquid crystal display (LCD)) and a user interaction interface (e.g., a keyboard, a mouse, or a touch input device). All components of the electronic device 800 may be connected to each other through a bus and/or a network.

According to an example, a computer-readable storage medium storing instructions may be further provided, and when the instructions are executed by at least one computing device, the at least one computing device executes the model compression method.

Examples of a non-transitory computer-readable storage medium may include read-only memory (ROM), random access programmable read-only memory (PROM), electrically erasable programmable read-only memory (EEPROM), random-access memory (RAM), dynamic RAM (DRAM), static RAM (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), card memory (e.g., a multimedia card, a secure digital (SD) card, or an extreme digital (XD) card), magnetic tapes, floppy disks, magneto-optical data storage devices, optical data storage devices, hard disks, solid-state disks, and any other device. The any other device may store computer programs and any associated data, data files, and data structures in a non-transitory manner and provide the computer programs and any associated data, data files, and data structures to a processor or computer so that the processor or computer may execute the computer programs. The computer programs in the non-transitory computer-readable storage medium may run in an environment deployed in a computer device such as a client, a host, a proxy device, a server, and the like. In an example, the computer programs and any associated data, data files and data structures may be distributed over network-coupled computer systems so that the computer programs and any associated data, data files, and data structures may be stored, accessed, and executed in a distributed fashion by one or more processors or computers. The instructions may also be used to execute additional operations in addition to the above operations, or to perform more specific processing when executing the performing the above operations. The details of these additional operations and additional processes have been described in the related methods and are not described repeatedly herein to avoid duplication.

Another example relates to a system including at least one computing device and at least one storage device storing instructions, wherein when the instructions are executed by the at least one computing device, the at least one computing device performs the model compression method.

The system according to an example may rely on the operation of a computer program or instructions to implement the functionality. That is, each unit (e.g., the first inputter, the pruning processor, the second inputter, the trainer, the loss calculator, and the model compressor) corresponds to each stage of the functional architecture of the computer program, so that the entire system may be called through a dedicated software package (e.g., lib library) to implement the corresponding function.

Meanwhile, when the system is implemented as software, firmware, middleware, or microcode, the program code or code segment used to perform the operation is stored in a computer-readable medium such as a storage medium, so that at least one processor or at least one computing device may read and execute the program code or code segment to perform the operation.

According to an example, the storage device may be integrated with the computing device, for example, a RAM or a flash memory may be arranged in an integrated circuit microprocessor or the like. In addition, the storage device may include a separate device such as an external disk drive, a storage array, or any other storage devices that may be used by a database system. The storage device and the computing device may be operatively connected or may communicate with each other through, for example, an 1/O port or a network connection, so that the processor may read files stored in the storage device.

Another example relates to a computer program product including a computer program/instructions, and when the computer program/instructions are executed by a processor, the model compression method is implemented.

According to the model compression method and apparatus, the electronic device, the storage medium, the system, and the computer program product provided in the examples, an end-to-end model compression method combining pruning and knowledge distillation is proposed. The student model 340 may be obtained by pruning the randomly initialized to-be-compressed model 310, using an automatic pruning method based on gating network pruning 330, and knowledge distillation may be performed based on the student model 340 and the teacher model 320. The final lightweight student model 341 may be obtained according to the gating network pruning 330 by optimizing the gating network pruning 330 while optimizing parameters of the to-be-compressed model 310 using the distillation loss 360. The model compression method may include performing joint optimization during the lightweight process by integrating the pruning and the knowledge distillation, simultaneously selecting redundant network structures and receiving information supervision of the teacher model 320, and simultaneously optimizing the network structure while performing knowledge distillation to obtain a compressed model with improved performance.

In addition, to facilitate the fusion of pruning and knowledge distillation algorithms, importance scores may be learned using only a fully connected layer of a single layer in the gating network pruning 330, thereby reducing the difficulty of parameter optimization.

In addition, the multi-scale spatial attention feature extractor 350 may be introduced for the knowledge distillation method, which performs knowledge distillation by extracting multi-scale spatial attention information of the outputs of the teacher model 320 and the student model 340 as constraints. That is, by calculating the distillation loss 360 using multi-scale high-frequency information of an extracted multi-scale spatial attention feature map, the student model 340 may learn the high-frequency information of different scales of the teacher model 320 more effectively, thereby improving the performance of the student model 340, i.e., the accuracy of the compression model. In addition, it may effectively improve distillation accuracy, enabling end-to-end joint optimization of pruning and distillation.

The computing apparatuses, the electronic devices, the processors, the memories, the displays, the information output system and hardware, the storage devices, and other apparatuses, devices, units, modules, and components described herein, including descriptions with respect to respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-8 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A method of compressing an artificial neural network model, the method comprising:
obtaining a first output of a to-be-compressed model by inputting training data to the to-be-compressed model and obtaining a second output of a teacher model by inputting the training data to the teacher model;
obtaining a student model by pruning the to-be-compressed model using a gating network pruning network based on the first output of the to-be-compressed model;
obtaining an output of the student model by inputting the training data to the student model;
calculating a distillation loss based on the output of the student model and the second output of the teacher model;
training the to-be-compressed model and the gating network pruning network based on the distillation loss; and
obtaining a compressed model by pruning the trained to-be-compressed model with the trained gating network pruning network.

2. The method of claim 1, wherein
the gating network pruning network comprises a gating network and a pruning mask, the gating network comprising a fully connected layer and a gating function, and
the obtaining of the student model by pruning the to-be-compressed model through the gating network pruning network based on the output of the to-be-compressed model, comprises:
in a forward inference process, obtaining an output of the fully connected layer by inputting, to the fully connected layer, an output of a to-be-compressed layer of the to-be-compressed model;
calculating a pruning threshold value based on a preset pruning ratio;
generating the pruning mask using the gating function based on the output of the fully connected layer and the pruning threshold value; and
obtaining the student model by pruning the to-be-compressed model based on the pruning mask.

3. The method of claim 2, wherein the gating network pruning network calculates a gradient of the gating function based on an approximate gating function in a backpropagation process.

4. The method of claim 1, wherein the calculating of the distillation loss based on the first output of the student model and the second output of the teacher model comprises:
extracting a first multi-scale spatial attention feature of the output of the student model by inputting the output of the student model to a multi-scale spatial attention feature extractor, and extracting a second multi-scale spatial attention feature of the second output by inputting the second output to the multi-scale spatial attention feature extractor; and
calculating the distillation loss based on the first multi-scale spatial attention feature and the second multi-scale spatial attention feature.

5. The method of claim 4, wherein the training of the to-be-compressed model and the gating network pruning network based on the distillation loss comprises:
training the to-be-compressed model, the gating network pruning network, and the multi-scale spatial attention feature extractor based on the distillation loss.

6. The method of claim 4, wherein the calculating of the distillation loss based on the first and second multi-scale spatial attention features comprises:
calculating a first loss based on a difference between the output of the student model and corresponding ground truth data in the training data;
calculating a second loss based on a difference between the first multi-scale spatial attention feature and the second multi-scale spatial attention feature; and
calculating the distillation loss based on the first loss and the second loss.

7. The method of claim 4, wherein the extracting of the first and second multi-scale spatial attention features comprises:
extracting a first feature by inputting the output of the student model or the second output to a first convolutional layer of the multi-scale spatial attention feature extractor;
extracting a second feature and a third feature by inputting the first feature to a second convolutional layer of the multi-scale spatial attention feature extractor and a third convolutional layer of the multi-scale spatial attention feature extractor, respectively;
obtaining a concatenation feature by concatenating the first feature, the second feature, and the third feature; and
obtaining the first multi-scale spatial attention feature or the second multi-scale spatial attention feature by inputting the concatenation feature to a fourth convolutional layer of the multi-scale spatial attention feature extractor.

8. The method of claim 7, wherein a receptive field of the second feature and a receptive field of the third feature are different from each other.

9. The method of claim 2, wherein the generating of the pruning mask using the gating function based on the output of the fully connected layer and the pruning threshold value comprises:
assigning 1 to a corresponding value among the pruning mask for a value greater than or equal to the pruning threshold value among the output of the fully connected layer; and
assigning 0 to a corresponding value among the pruning mask for a value less than the pruning threshold value among the output of the fully connected layer.

10. The method of claim 1, wherein the to-be-compressed model is obtained by random initialization, the teacher model is obtained through pre-training, and network structures of the to-be-compressed model and the teacher model correspond to each other.

11. An apparatus for compressing an artificial neural network model, the apparatus comprising:
one or more processors; and
a memory storing instructions configured to, when executed by the one or more processors, cause the apparatus to:
obtain a first output of a to-be-compressed model by inputting training data to the to-be-compressed model and obtaining a second output of a teacher model by inputting the training data to the to the teacher model;
obtain a student model by pruning the to-be-compressed model through a gating network pruning network based on the first output of the to-be-compressed model;
obtain an output of the student model by inputting the training data to the student model;
calculate a distillation loss based on the output of the student model and the second output of the teacher model;
train the to-be-compressed model and the gating network pruning network based on the distillation loss; and
obtain a compressed model by pruning the trained to-be-compressed model, using the trained gating network pruning network.

12. The apparatus of claim 11, wherein
the gating network pruning network comprises a gating network and a pruning mask, and wherein the gating network comprises a fully connected layer and a gating function, and
the instructions are further configured to cause the apparatus to:
in a forward inference process, obtain an output of the fully connected layer by inputting, to the fully connected layer, an output of a to-be-compressed layer of the to-be-compressed model;
calculate a pruning threshold value based on a preset pruning ratio;
generate the pruning mask using the gating function based on the output of the fully connected layer and the pruning threshold value; and
obtain the student model by pruning the to-be-compressed model based on the pruning mask.

13. The apparatus of claim 12, wherein the gating network pruning network calculates a gradient of the gating function based on an approximate gating function in a backpropagation process.

14. The apparatus of claim 11, wherein the instructions are further configured to cause the apparatus to:
extract a first multi-scale spatial attention feature of the output of the student model and a second multi-scale spatial attention feature of the second output of the teacher model by inputting the output of the student model and the second output of the teacher model to a multi-scale spatial attention feature extractor, respectively; and
calculate the distillation loss based on the first multi-scale spatial attention feature and the second multi-scale spatial attention feature.

15. The apparatus of claim 14, wherein the instructions are further configured to cause the apparatus to train the to-be-compressed model, the gating network pruning, and the multi-scale spatial attention feature extractor based on the distillation loss.

16. The apparatus of claim 14, wherein the instructions are further configured to cause the apparatus to:
calculate a first loss based on a difference between the output of the student model and corresponding ground truth data in the training data;
calculate a second loss based on a difference between the first multi-scale spatial attention and the second multi-scale spatial attention feature; and
calculate the distillation loss based on the first loss and the second loss.

17. The apparatus of claim 14, wherein the instructions are further configured to cause the apparatus to:
extract a first feature by inputting the output of the student model or the second output to a first convolutional layer of the multi-scale spatial attention feature extractor;
extract a second feature and a third feature by inputting the first feature to a second convolutional layer of the multi-scale spatial attention feature extractor and a third convolutional layer of the multi-scale spatial attention feature extractor, respectively;
obtain a concatenation feature by concatenating the first feature, the second feature, and the third feature; and
obtain the first multi-scale spatial attention feature or the second multi-scale spatial attention feature by inputting the concatenation feature to a fourth convolutional layer of the multi-scale spatial attention feature extractor.

18. The apparatus of claim 17, wherein a receptive field of the second feature and a receptive field of the third feature are different from each other.

19. The apparatus of claim 12, wherein the instructions are further configured to cause the apparatus to:
assign 1 to a corresponding value among the pruning mask for a value greater than or equal to the pruning threshold value among the output of the fully connected layer; and
assign 0 to a corresponding value among the pruning mask for a value less than the pruning threshold value among the output of the fully connected layer.

20. An electronic device comprising:
one or more processors comprising processing circuitry; and
a memory storing instructions,
wherein the instructions, when executed by the one or more processors, cause the electronic device to:
obtain a first output of a student model and an output of a corresponding teacher model by inputting a training data item to the student model and to the teacher model, respectively;
prune the student model through gating network pruning based on the first output of the student model;
obtain a second output of the student model by inputting the training data item to the pruned student model;
calculate a loss based on the second output of the student model and the output of the teacher model;
train the student model and the gating network pruning based on the loss; and
prune the trained student model through the trained gating network pruning.
